(19) United States
(12) Patent Application Publication
(10) Pub. No.: US 2004/0236503 A1
(43) Pub. Date: Nov. 25, 2004

(54) Algorithmic functions for scheduling systems and methods to move transportation objects through a single route in skip-stop fashion

(76) Inventors: Vitaliy L. Lyakir, Brooklyn, NY (US); Alla Litovchenko, Needham, MA (US); Dmitry Denikin, Bulger, PA (US)

Correspondence Address: ALLA LITOVCHENKO, 855 GREAT PLAIN AVENUE, NEEDHAM, MA, 02492, US

(21) Appl. No.: 10/443,170

(22) Filed: May 23, 2003

(51) Int. Cl. G01C 21/26

(52) U.S. Cl. 701/201; 701/202

(57) ABSTRACT

Transportation system members' the functional optimization with new scheduling methods whereas vehicles' movement through a single route in skip-stop fashion due to application of algorithmic functions to uniform vehicle movement with extra benefits from multiple resources availability.

### CROSS-REFERENCE TO RELATED APPLICATIONS

U.S. patent documents:

U.S. Pat. No. 4,924,386 May 8, 1990 Freedman

U.S. Pat. No. 5,038,290 Aug. 6, 1991 Minami

U.S. Pat. No. 5,177,684 Jan. 5, 1993 Harker

U.S. Pat. No. 5,541,845 Jul. 30, 1996 Klein

U.S. Pat. No. 5,623,413 Apr. 22, 1997 Matheson

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF INVENTION

The invention relates to the method of algorithmic function utilization for transportation scheduling. In particular, the invention provides substantially optimal vehicle schedules with respect to operation cost resulting from decrease in the energy loss caused by unnecessary vehicle acceleration.

The Standard City Traffic Statistical Estimations recognize an energy loss by various transportation objects due to vehicle inertia caused with its acceleration after frequent stopping and which is running at an average from 40% to 80% of BTU (fuel).

Common practice to employ a random order of Skip-Stop Service topography leads to random mode of temporal scheduling sequences resulting in the necessity to apply exceptions to a regular service schedule followed after daily technical equipment disruptions.

Such practices lift the cost of operations on city transport of the plural kind, the public, privately owned and of mixed ownership.

A reason for a new type of scheduling employing algorithmic function utilization come from the fact that transportation stops topography reflects the needs of only one part of a transportation system member, which are passengers. Neglecting the other members' convenience leads to resources shortage. Heretofore sequences translate technical disadvantages to the first transportation system member, to the passenger.

An idea to save energy by employing various skipping-of-stations methods for transportation service was never implemented as systematic replacement for the Local (stop at every station) Service on an overall basis. One of a few reasons why known methods have not been effective is an attempt to utilize both Local and Skip-Stop services on the same path and to skip stations randomly. Therefore it has been difficult to educate customers in a new stop schedule. For example, the New York Metropolitan Transit Authority's experiment with broad implementation of a skip-stop scheduling on the New York Subway in the mid-1980's was abandoned in proposed schedule after numerous complaints, in particular in difficulty reading the subway map.

Another example are numerous Rail Road Scheduling Systems as decrypted in United States patents in particular under U.S. Pat. Nos. 5,177,684 and 5,623,413. Both patents in fact approach the scheduling method differently than the present method. In particular, by applying its original algorithms for improving service on a single overloaded station, they make their achievements accordingly. However not The Implicit Enumeration Algorithm, nor The Lower Bound-Based Exact Pruning Algorithm, or even The Accelerated Heuristic Lower Bound-Based Algorithm are targeting an improvement on the operation cost by scheduling different sets of vehicles to serve a single route on the same algorithm mode.

Running in express fashion passenger transport can not cover many important destinations. Otherwise, multiple local stops slow down the service speed. The system now in use contains drawbacks for such a type of local transport in plurality of vehicle classes caused by occurred expansion of serviced areas during the last few decades.

By now, daily trips grow too long, suggesting passengers to switch from commercial into individual transportation in an attempt to reach their destination faster. Larger number of stations emerged on the route cause more difficulty to keep the service schedule uninterrupted with emergencies. While the number of stops is increasing with every new station on a route, all minor inequities in time requirement to cover different distances between stops are collecting together along with inequities in vehicle-reloading time required at stations. Therefore, transportation units' speed keeps being increasingly non-constant.

Busy parts of such a transportation route contain merged areas and have shorter distances between stations. Such an area tends to accumulate more vehicles together and causes them not to fit in at a certain time. This causes a break in the time approximation schedule. Then rush-hour traffic is flooded with its famous jam.

### BRIEF SUMMARY OF INVENTION

The request for replacing comparatively inefficient in respect to time cost and economic resources, passenger local service with uniformed skip-stop service is based on the idea to benefit from minimization of vehicle acceleration to get the same result for energy lost heretofore or otherwise to get an increase in speed and passenger capacity of transportation equipment accordingly.

A general schema is to employ a transportation system where all stations on each route will be served with vehicles scheduled to stop in different stations for passenger service and having few mutual stops or otherwise a connection vehicle for interfering with each other.

Accordingly, it is an object of the present invention to obviate the above deficiencies of known systems and to provide a novel system and method for scheduling the movement of passenger vehicles through a one-route Transportation System.

It is another object of the present invention to provide a novel system and method for optimizing the movement of passenger vehicles through a one-route Transportation System.

It is yet another object of the present invention to provide a novel system and method for optimization with consideration of energy savings and operations cost.

These and many other objects and advantages of the present invention will be readily apparent to one skilled in the art to which the invention pertains from a perusal of the claims, the appended drawings, and the following detailed description of the preferred embodiments.

As is readily apparent, the system and method of the present invention is advantageous in several aspects.

By avoiding economically disadvantaged stops and acceleration afterwards with all named above classes of passenger vehicles, certain amounts of energy will be saved.

By the ability of the passenger vehicles to speed through stations at a greater volume of the service will be achieved without additional spending.

By having passenger vehicles working faster, fewer vehicles and fewer drivers will be employed to perform the same required amount of service. Alternatively, the size and capacity of passenger vehicles can be reduced instead.

In various Transportation Systems employing electric vehicles, it is possible to achieve an additional savings by lowering the amount of energy in the electric circuit in case to employ shorter trains instead of decreasing the vehicles quantity on line.

The saved energy of electrical resistance is equal to a decrease in current: R=V/I;

### BRIEF DESCRIPTION OF THE SEVERAL VIEWS OF THE DRAWING

FIG. 1 is a diagram that illustrates a method with an example of a typical scheduling for two Liners on the same path, having no mutual stops for intersection and a Shadow Connector.

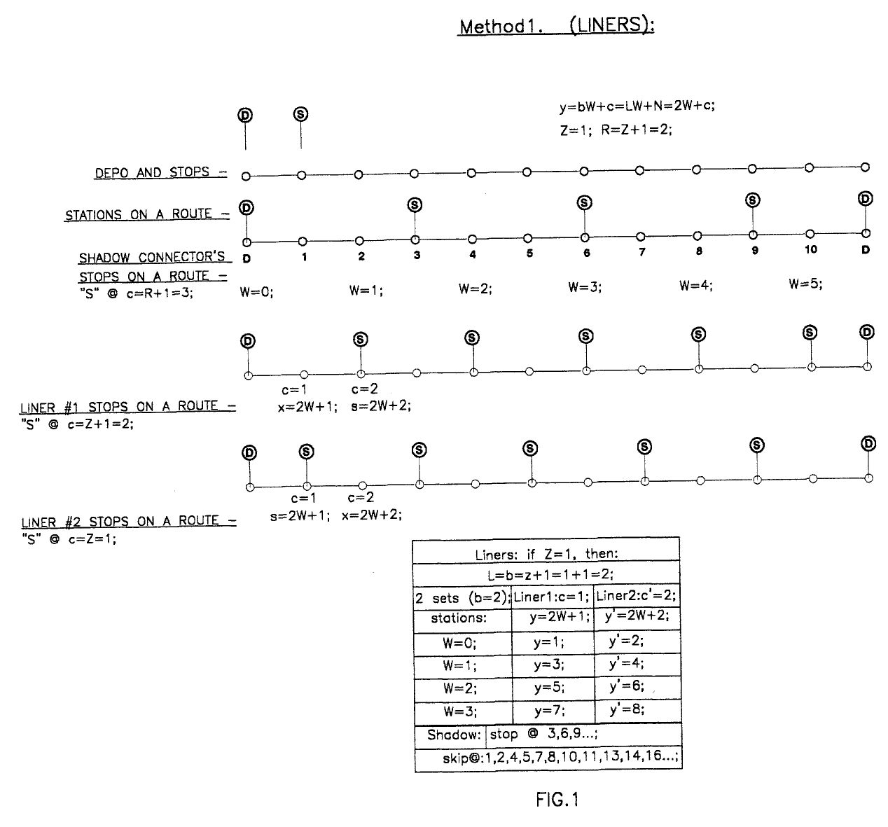

FIG. 2 is a diagram that illustrates a method with an example of a typical scheduling for three Liners on the same path, having no mutual stops for intersection and a Shadow Connector.

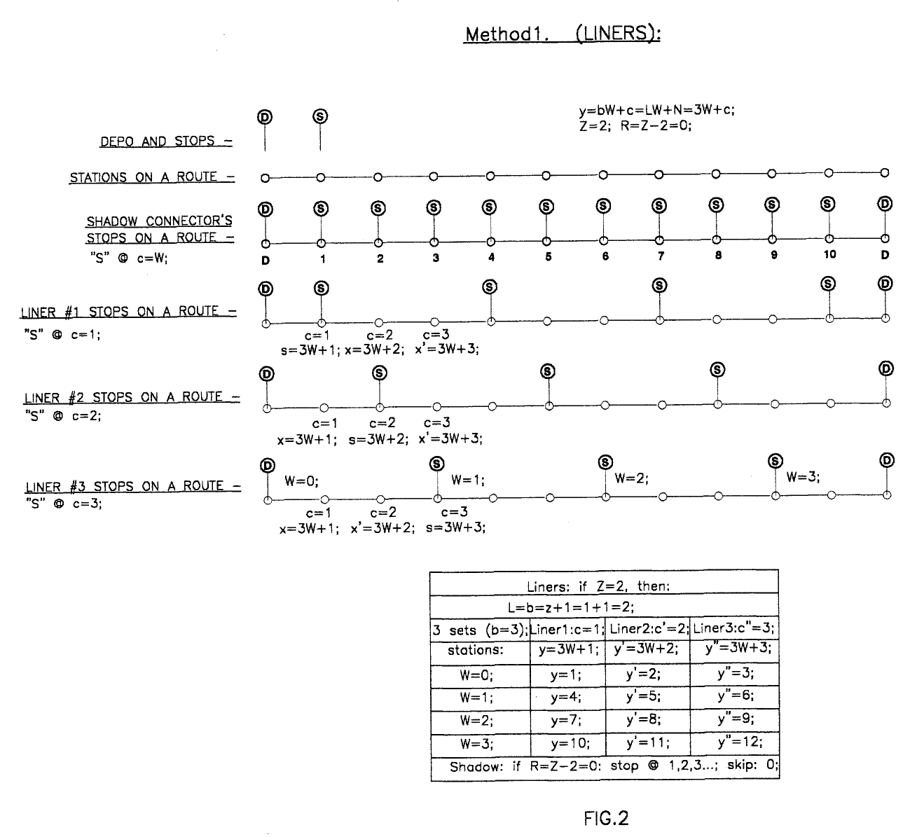

FIG. 3 is a diagram that illustrates a method with an example of a typical scheduling for two Liners serving different stations on the same path and having designated mutual stops for intersection with each other.

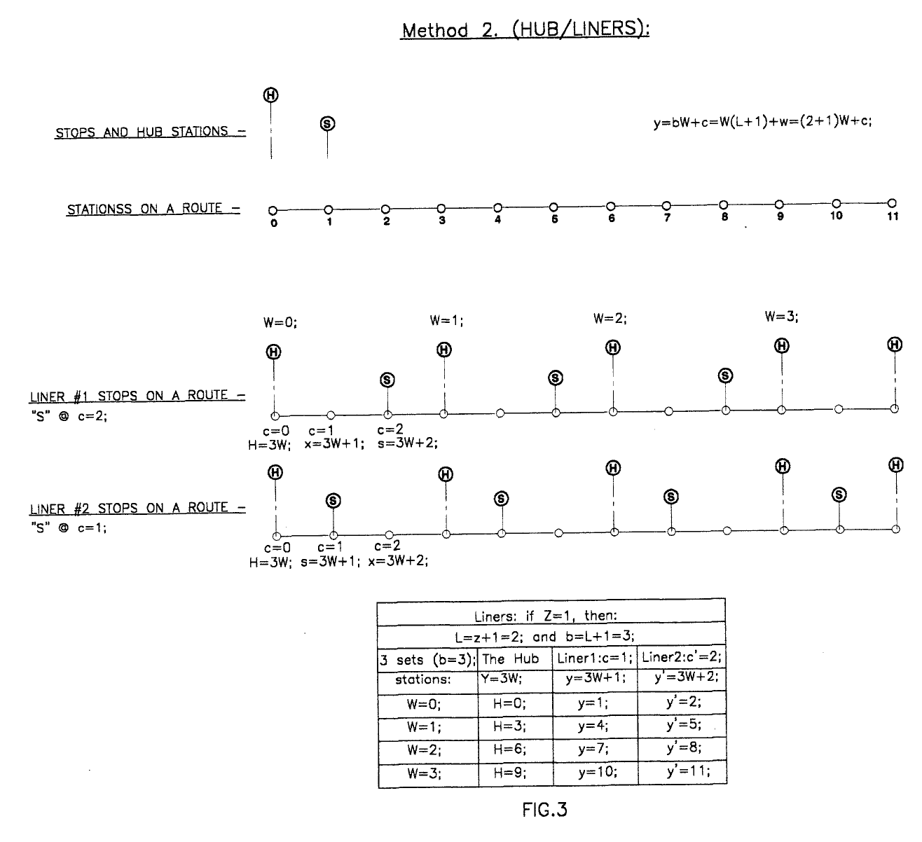

FIG. 4 is a diagram that illustrates a method with an example of a typical scheduling for three Liners serving different stations on the same path and having designated mutual stops for intersection with each other.

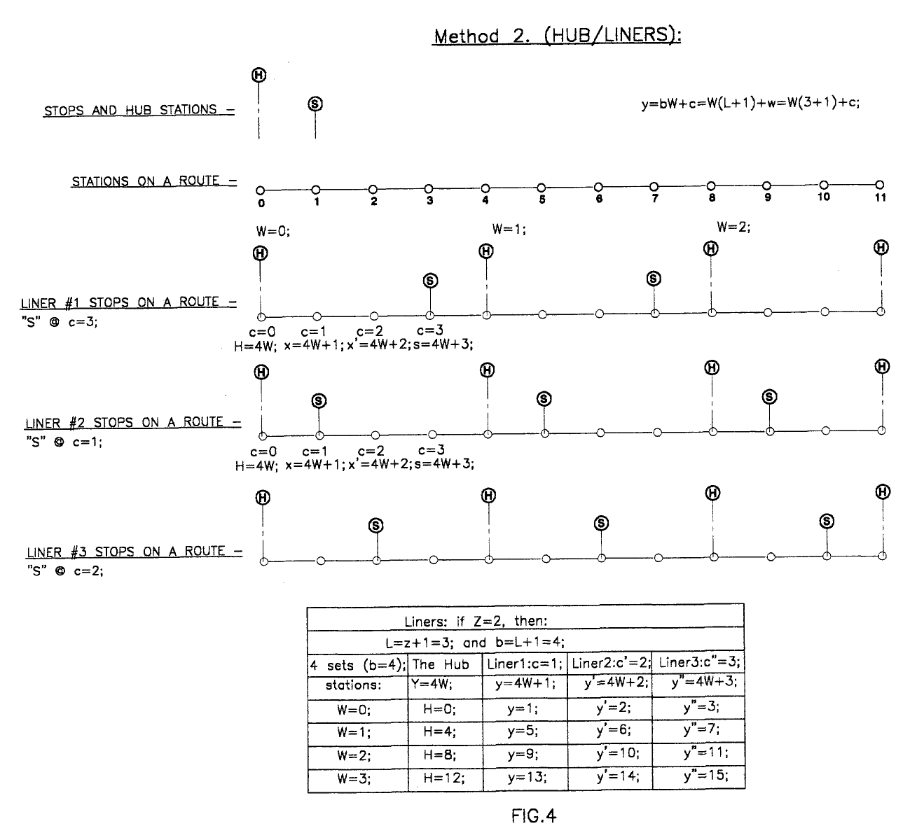

FIG. 5 is an introduced scheduling methods' the algorithms.

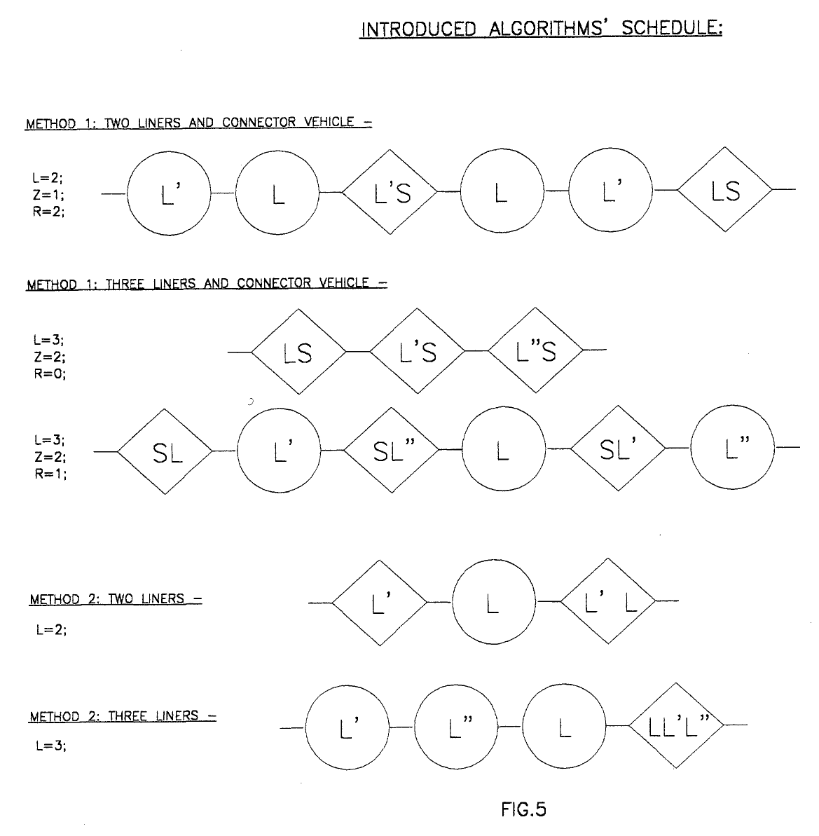

### DETAILED DESCRIPTION OF THE INVENTION

A present attempt is to reflect all transportation system members' functional convenience in the scheduling of a new type, where employed algorithmic functions make vehicle movement uniform which results in extra availability in multiple resources.

To compete with private cars with more success, City Transportation Governments are encouraged to accept two types of the short-distance service transportation disregarding the form of its ownership. One is to be buses as a Local Connector with multiple stops and second to be buses or otherwise city train running both in skip-stop fashion. Both skip-stop scheduled vehicles to be City District Connectors, means moving fast from area to area in distances smaller than express service of both vehicle types. These faster moving District Connectors result in significant savings on resources. Saving on inertia lost is expected due to minimizing the quantity of served stops and acceleration afterwards. Additional savings can be made with reducing the number of vehicles required to perform an equal volume of passenger service with the same capacity transportation units. This can result from moving at higher speed due to stops partial elimination and reloading time decreasing theretofore, and due to uniformed schedule execution resulted from extra energy and space resources availability, etc.

The request for replacing or combining an inefficient and expansive local service with uniformed skip-stop service based on optimal distance between stations to achieve constant overall speed can be satisfied with two methods.

First, is a new scheduling system for multiple vehicle types whereas:

All stations existed (or newly built) on a single route within a distance not exceeding a 10-20 minute walking from each other will be served with a few sets of transport units (Liners) all having no mutual stops. Every member of such a set is due to skip each named hereafter number of stations. A Shadow Connector will perform the connection between different sets of Liners, typically on the same route or otherwise connecting parallel and intersecting passes.

A service schedule utilizes the following algorithms:

Each Liner of any set is due to skip a certain quantity of stops (z) between two neighboring served stations;

“z” is any convenient natural number.

Quantity of sets of Liners (L) will depend on this quantity of stops due to skip:

L=z+1;

On every path, each particular station can be found as route “y” of the typical linear equation:

y=bx+c; where:

Coefficient “b” of the variable represents total quantity of sets of Liners “L” (b=L);

A variable “x” is defined by the set of whole numbers “W” (W=0,1,2, . . . W) or:

xUW; and represents each distinctive Liners' set on the same path.

A free member “c” is defined by a set of natural numbers “N” (1,2,3, . . . b) or: cUN; between 1 and b including both.

Each free member “c” in each route corresponds to a particular set of Liners on a single path.

Each free member “c” value coordinates with corresponding numbers of Liner's set (L#) directly or with various modulations (reverse numeration, etc) in a sequence accordingly its definition.

Herein:

y=LW+c;

or: y=W(z+1)+N;

The number of stops skipped by every Shadow Connector “R” is any conveniently different from “z”:

R=z+/N/; (RUW);

then: R<z; or R>z;

for Shadow Connectors all stations: y (shadow)=y+/N/;

Shadow Connectors quantity is “as required”. All Shadow Connectors belong to one set.

Alternatively all stations mentioned above in the first scheduling method could be served solely with Liners. In this alternative method, all vehicles do have mutual stops (Hubs) in addition to stops being served separately by different train sets.

On the new scheduling method, each particular stop can be found on a path as multiple routes of the same linear function

y=bx+c

where the value of the variable's coefficient will be b=L+1;

accordingly: L=z+1;

herein: y=W(L+1)+c; or: y=W(z+2)+w;

In this method, a free member “c” is defined by set of whole numbers (w=0,1,2, . . . L) between 0 and L including both.

No correlation between “w” and “W” is necessary.

For all Hubs (H): c=0; for served stations (s) a free member “c” value coordinates with corresponding numbers of liner's set (L#) directly or with various modulation (reverse numeration, etc) in a sequence according to its definition.

1. The uniform system for planning the vehicle's movement through the one-route transportation system.

2. The methods for using an algorithmic function for seeking a transportation schedule wherein the operating costs are minimized, etc.

3. The methods for using an algorithmic function for seeking a transportation schedule wherein the operational speed and other technical features are maximized.
